(19) United States
(12) Patent Application Publication
(10) Pub. No.: US 2017/0333931 A1
(43) Pub. Date: Nov. 23, 2017

(54) TRIGGER-TYPE LIQUID DISPENSER

(71) Applicants: Kotaro FUJIWARA, Koto-ku, Tokyo (JP); Shigeo IIZUKA, Koto-ku, Tokyo (JP)

(72) Inventors: Kotaro FUJIWARA, Koto-ku, Tokyo (JP); Shigeo IIZUKA, Koto-ku, Tokyo (JP)

(73) Assignee: YOSHINO KOGYOSHO CO., LTD., Tokyo (JP)

(21) Appl. No.: 15/536,563

(22) PCT Filed: Nov. 20, 2015
(86) PCT No.: PCT/JP2015/005804

§ 371 Date: Jun. 15, 2017

(30) Foreign Application Priority Data
Dec. 26, 2014 (JP) 2014-265113

(51) Int. Cl. B05B 11/00; B05B 1/12; B05B 7/00

(52) U.S. Cl. CPC B05B 11/3057; B05B 11/3045; B05B 1/12; B05B 11/0032; B05B 7/005

(57) ABSTRACT

A trigger-type liquid dispenser includes a dispenser main body, pump, and nozzle. The body includes a fitted portion, which communicates with a delivery port. The nozzle includes a partition wall, which covers an opening end of the fitted portion and has a dispensing hole, and an outer circumferential wall. The nozzle is rotatable with respect to the fitted portion between an opened position, wherein the hole communicates with the port, and a closed position, wherein the hole is blocked. The outer circumferential wall includes a locking projection, in undercut engagement with a projecting portion, on an outer surface of the fitted portion, to hold the nozzle in engagement with the fitted portion. The locking projection, in an inner edge portion thereof, has a concave portion, wherein the degree of undercut engagement with the projecting portion is reduced when the nozzle is located between the opened and the closed position.

### TECHNICAL FIELD

The present disclosure relates to a trigger-type liquid ejection device (hereinafter, called the trigger-type liquid dispenser) that is attached to a mouth of a container containing a liquid and that dispenses the liquid contained in the container through a nozzle.

### BACKGROUND

Dispensers may be attached to mouths of containers containing liquids, such as an antimold, a detergent, a sizing agent for textiles, household wax, a hair liquid, an aromatic, a repellent, a pesticide, and a medicine. As an example of such a dispenser, an existing trigger-type liquid dispenser dispenses such a liquid in the form of spray or foam through a nozzle by actuating a pump in response to operation of a trigger.

Such a trigger-type liquid dispenser includes a dispenser main body fitted to the mouth of the container by, for example, a fitting cap. The dispenser main body is fitted with a pump and is also provided with a delivery flow path of the liquid pressure-fed to the pump, and the nozzle is fitted to a delivery port, which is an outlet end of the delivery flow path. The nozzle is provided with a dispensing hole having a smaller diameter than the delivery flow path. After pressure-fed to the delivery port through the delivery flow path by the pump, the liquid is dispensed to the outside through the dispensing hole. It is also known that, in some cases, the nozzle is fitted rotatably to the dispenser main body and that rotating the nozzle permits the dispensing hole to be switched between an opened and a closed state.

Such a nozzle is generally formed into a shape including a partition wall provided with the dispensing hole, a cylindrical outer circumferential wall integrally provided around an outer circumference of the partition wall, and an annular locking projection integrally provided on an inner circumferential surface of the outer circumferential wall to protrude from the inner circumferential surface toward the inner side in the radial direction, by injection molding a resin material with use of a mold. On the other hand, the dispenser main body is provided integrally with a cylindrical fitted portion that communicates with the delivery port. The fitted portion is also provided, on an outer circumferential surface thereof, with a projecting portion integrally. With the outer circumferential wall of the nozzle being fitted to the outer side of the fitted portion and with the locking projection of the nozzle being in undercut engagement with the projecting portion, the nozzle is rotatably fitted to the fitted portion while being engaged with the fitted portion.

### CITATION LIST

### Patent Literature

PTL1: JPH11290731A

### SUMMARY

### Technical Problem

In the trigger-type liquid dispenser, a large amount of the liquid is dispensed in the form of spray or foam through the small dispensing hole provided in the nozzle. This means that pressure is increased in the delivery flow path and in the nozzle at the time of dispensing the liquid. Accordingly, fitting strength of the nozzle with respect to the fitted portion needs to be enhanced by increasing the degree of overlap in the undercut engagement between the locking projection, which is provided on the outer circumferential wall of the nozzle, and the projecting portion, which is provided on the outer circumferential surface of the fitted portion.

However, the attempt to increase the degree of overlap in the undercut engagement poses the following problem. That is to say, when the nozzle is fitted to the outer side of the fitted portion, the locking projection strongly contacts the projecting portion, and plastic deformation so-called a burr occurs. This causes a variation in position of the nozzle fitted to the fitted portion of the dispenser main body.

Accordingly, the present disclosure is to provide a trigger-type liquid dispenser that maintains the fitting strength of the nozzle with respect to the fitted portion sufficiently and that also improves fitting stability of the nozzle by preventing the plastic deformation caused when the nozzle is fitted.

### Solution to Problem

One of aspects of the present disclosure resides in a trigger-type liquid dispenser including: a dispenser main body fitted to a mouth of a container containing a liquid; a pump configured, in response to operation of a trigger, to be actuated to pressure-feed the liquid contained in the container to a delivery port through a delivery flow path provided in the dispenser main body; and a nozzle fitted to the dispenser main body to dispense, to outside, the liquid pressure-fed to the delivery port. The dispenser main body includes a cylindrical-shaped fitted portion communicating with the delivery port. The nozzle includes a partition wall, which covers an opening end of the fitted portion and which is provided with a dispensing hole, and a tubular-shaped outer circumferential wall, which is contiguous with an outer circumference of the partition wall to cover an outer circumference of the fitted portion. The nozzle is rotatable with respect to the fitted portion between an opened position, in which the dispensing hole communicates with the delivery port, and a closed position, in which the dispensing hole is blocked from the delivery port. The outer circumferential wall includes a locking projection that protrudes toward an inner side in a radial direction from an inner circumferential surface of the outer circumferential wall and that is in undercut engagement with a projecting portion provided on an outer circumferential surface of the fitted portion to thereby hold the nozzle in engagement with the fitted portion. The locking projection is provided, in an inner edge portion thereof, with a concave portion, in which a degree of the undercut engagement with the projecting portion is reduced when the nozzle is located between the opened and the closed position.

In a preferred embodiment of the trigger-type liquid dispenser according to the present disclosure, the nozzle is configured in a manner such that the nozzle comes to the closed position when being rotated 90 degrees to one side with respect to the fitted portion from the opened position, and the concave portion is arranged to engage with the projecting portion in a state where the nozzle is rotated 45 degrees in a direction toward the closed position from the opened position.

In another preferred embodiment of the trigger-type liquid dispenser according to the present disclosure, the outer circumferential wall includes a rib that protrudes toward the inner side in the radial direction from the inner circumferential surface of the outer circumferential wall and that abuts against the projecting portion in a state where the locking projection is in undercut engagement with the projecting portion.

In yet another preferred embodiment of the trigger-type liquid dispenser according to the present disclosure, the nozzle includes: a nozzle main body in which the partition wall and the outer circumferential wall are formed integrally; and a nozzle cap body that is fitted to the nozzle main body, that is configured to cover the dispensing hole in an openable and closable manner via a hinge, and that is configured to change a dispensing form.

### Advantageous Effect

The present disclosure provides a trigger-type liquid dispenser that maintains the fitting strength of the nozzle with respect to the fitted portion sufficiently and that also improves the fitting stability of the nozzle by preventing the plastic deformation caused when the nozzle is fitted.

### BRIEF DESCRIPTION OF THE DRAWINGS

In the accompanying drawings:

FIG. 1 is a side sectional view of a trigger-type liquid dispenser according to one of embodiments of the present disclosure;

FIG. 2 is an enlarged sectional view illustrating a trigger-type liquid dispenser of FIG. 1; and

FIG. 3A is a pair of a front view and an X-X sectional view illustrating a nozzle and a fitted portion of a trigger-type liquid dispenser of FIG. 1, and

FIG. 3B is a pair of a front view and a Y-Y sectional view illustrating how a nozzle is fitted to a fitted portion.

### DETAILED DESCRIPTION

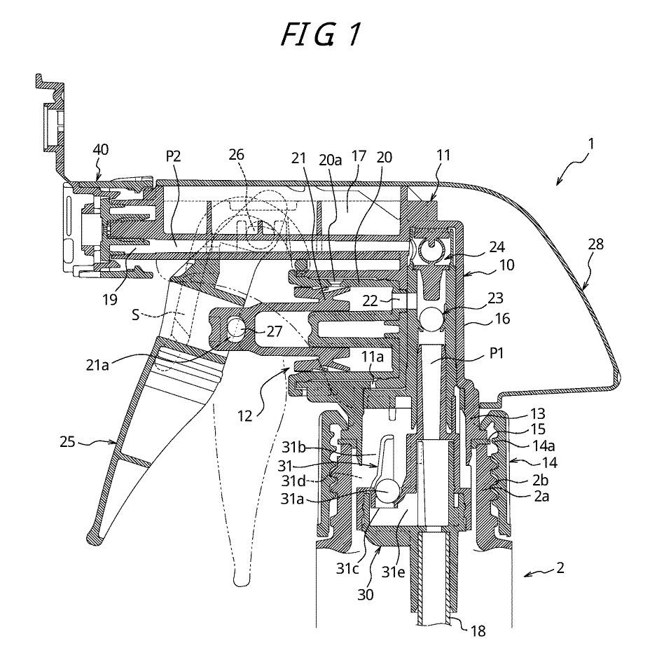

The present disclosure will be described in more detail below by illustration with reference to the drawings. Note that, in the specification, the claims, the abstract, and the drawings herein, the side (corresponding to the upper side in FIG. 1) on which a ceiling wall of a shroud included in a dispenser main body, which is later described, is located is defined as upper direction, and the side (corresponding to the lower side in FIG. 1) on which a fitting cap is disposed is defined as lower direction. Furthermore, the side (corresponding to the left side in FIG. 1) on which the nozzle of the dispenser main body is disposed is defined as front direction, and the opposite side (corresponding to the right side in FIG. 1) is defined as rear direction. Moreover, the directions that are orthogonal to the upper-lower direction and the front-rear direction (the directions that are orthogonal to the drawing in FIG. 1) are defined as lateral sides (left and right directions).

A trigger-type liquid dispenser 1 according to one of embodiments of the present disclosure illustrated in FIG. 1 may be attached to a mouth 2a of a container 2 in use. The container 2 contains a liquid, such as an antimold, a detergent, a sizing agent for textiles, household wax, a hair liquid, an aromatic, a repellent, a pesticide, and a medicine, as the content liquid. FIG. 1 illustrates the state in which the trigger-type liquid dispenser 1 is attached to the mouth 2a of the container 2.

The trigger-type liquid dispenser 1 includes a dispenser main body 10, which is fitted to the mouth 2a of the container 2. The dispenser main body 10 includes a resin-made body portion 11 and a pump 12, which is fitted to the body portion 11.

A lower end of the body portion 11 serves as a coupling tube 13, and a fitting cap 14 is held to the coupling tube 13 in a manner such that the fitting cap 14 is rotatable relative to the coupling tube 13. The fitting cap 14 is formed in a cylindrical shape and is provided, on an inner circumferential surface thereof, with a female screw 14a. The body portion 11 is fixed to the mouth 2a of the container 2 by screw-connecting the female screw 14a to a male screw 2b, which is provided on an outer circumferential surface of the mouth 2a of the container 2, in the state where the coupling tube 13 is fitted to the mouth 2a of the container 2. Additionally, reference numeral 15 denotes a sealing member that seals between the mouth 2a of the container 2 and the coupling tube 13.

The body portion 11 is formed to have a substantially L-shape appearance including a standing portion 16, which extends from the coupling tube 13 in a direction extending along the central axis of the coupling tube 13, and also including an extension portion 17, which extends in a direction orthogonal to the standing portion 16. The standing portion 16 is provided inside thereof with an intake flow path P1, which communicates with the coupling tube 13. The intake flow path P1 has a lower end (corresponding to a lower end of an upright and inverted dual mechanism 30, which is described later) to which a drawing tube 18, which is inserted into the container 2, is connected. On the other hand, the extension portion 17 is provided with a delivery flow path P2, which extends in the direction orthogonal to the intake flow path P1. The delivery flow path P2 is provided, on a front end thereof, with a delivery port 19.

The pump 12 includes a cylinder 20, which is attached to the body portion 11, and a piston 21, which is displaceably assembled in the cylinder 20. The inside of the cylinder 20 communicates with the intake flow path P1 and the delivery flow path P2 via an outlet/inlet hole 22.

The intake flow path P1 is provided, in a portion thereof that is located on the lower side (i.e., on the upstream side) of the outlet/inlet hole 22, with the first check valve 23. The first check valve 23 operates to permit the liquid to flow from the inside of the container 2 toward the outlet/inlet hole 22 and to prevent the liquid, after being discharged through the outlet/inlet hole 22 in response to actuation of the pump 12, from flowing toward the container 2 through the intake flow path P1. Similarly, the delivery flow path P2 is provided, in a portion inside thereof that is located on the upper side (i.e., on the downstream side) of the outlet/inlet hole 22, with the second check valve 24. The second check valve 24 operates to permit the liquid, after being discharged through the outlet/inlet hole 22 in response to actuation of the pump 12, to flow toward the delivery port 19 through the delivery flow path P2 and to prevent the liquid from flowing from the delivery port 19 toward the outlet/inlet hole 22.

To the body portion 11, a trigger (operation lever) 25 is fitted. The trigger 25, on its one end side, is supported swingably by the body portion 11 about a pivot shaft 26. The trigger 25 is provided, in a middle portion thereof, with a pin member 27, which engages with a concave portion 21a, which is provided in a front end of the piston 21. Thus, the trigger 25 is rotatably coupled to the front end of the piston 21 by the pin member 27. With the trigger 25, a front end of a curve-shaped plate spring S, which has a base end fixed to and held by the body portion 10, is engaged. The plate spring S urges the trigger 25 toward a direction (i.e., a clockwise direction about the pivot shaft 26 in the figure) away from the pump 12. Additionally, the body portion 11 and the pump 12 are covered by a shroud 28, and the trigger 25 protrudes from the lower side of the shroud 28.

When the trigger 25 is pulled toward the pump 12 manually, the first check valve 23 is closed, and the piston 21 increases the liquid pressure inside the cylinder 20. Consequently, the liquid contained in the cylinder 20 is delivered from the outlet/inlet hole 22 into the delivery flow path P2 through the second check valve 24. On the other hand, when the trigger 25 is released from the operation, the trigger 25 is returned to its initial position due to resilience of the plate spring S. In conjunction with the return movement, the second check valve 24 is closed, the first check valve 23 is opened, and the liquid contained in the container 2 is drawn from the outlet/inlet hole 22 into the cylinder 21 via the tube 18 and the intake flow path P1. Additionally, the cylinder 20 is provided with an ambient air introduction port 20a, which is exposed to the outside when the trigger 25 is operated to its stroke limit. Air drawn through the ambient air introduction port 20a is then drawn into the container 2 through an annular-shaped gap defined between the cylinder 20 and the body portion 11, through a vent hole 11a, which is provided in the body portion 11, and through a gap defined between the upright and inverted dual mechanism 30 and the body portion 11. Accordingly, after the liquid is dispensed, the space in the container 2 is replaced with air. By thus repeating pulling and releasing operations of the trigger 25, the pump 12 may be actuated to draw the liquid contained in the container 2 through the intake flow path P1 and to pressure-feed the liquid to the delivery port 19 through the delivery flow path P2.

The body portion 11 and the pump 12 do not need to be configured as above, and it is possible to adopt a variety of configurations or structures, which permit the pump 12 to be actuated in response to operation of the trigger 25 to pressure-feed the liquid from the inside of the container 2 to the delivery port 19.

Between the intake flow path P1 and the tube 18, there is provided the upright and inverted dual mechanism 30, which permits the liquid contained in the container 2 to be supplied to the pump 12 regardless of whether the container 2, to which the trigger-type liquid dispenser 1 is fitted, is in an upright or an inverted position. The upright and inverted dual mechanism 30 includes a check valve unit 31. When the container 2 is in the upright position, the check valve unit 31 is in its closed state where a ball-shaped valve body 31a closes an outlet hole 31c of a valve chamber 31b, so that the liquid may be introduced to the intake flow path P1 via the tube 18. On the other hand, when the container 2 is placed in the inverted position, the check valve unit 31 is brought into its opened state by the valve body 31a being displaced in the valve chamber 31b in a direction away from the outlet hole 31c, so that the liquid pooled inside the coupling tube 13 may be introduced from an inlet opening 31d, which is provided in a side wall of the check valve unit 31, to the intake flow path P1 via the valve chamber 31b, the outlet hole 31c, and a flow path 31e, which is used during inversion. Thus, the liquid contained in the container 2 may be supplied to the pump 12 both in the upright and inverted positions.

To a front end of the extension portion 17 of the body portion 11, a nozzle 40 is fitted. The nozzle 40 is used to dispense the liquid, after being pressure-fed from the container 2 to the delivery port 19 by the pump 12, to the outside.

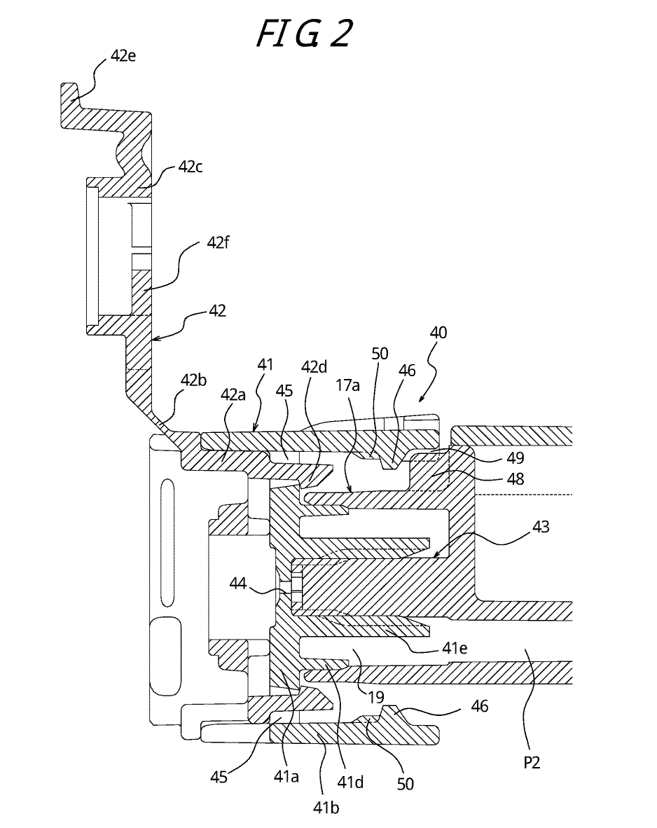

As illustrated in FIG. 2, the front end of the extension portion 17 of the dispenser main body 10 is provided integrally with a fitted portion 17a, to which the nozzle 40 is fitted. The fitted portion 17a is formed in a cylindrical shape protruding from the front end of the extension portion 17, and the delivery port 19, which is an outlet end of the delivery flow path P2, is open to the lower side of the inside of the fitted portion 17a. That is to say, the fitted portion 17a, in the inside thereof, communicates with the delivery port 19 of the delivery flow path P2. Furthermore, the front end of the extension portion 17 is provided integrally with a columnar-shaped switch shaft portion 43, whose central axis is aligned with the central axis of the fitted portion 17a.

In the present embodiment, the nozzle 40 has a double-block structure combining a nozzle main body 41 and a nozzle cap body 42. The nozzle main body 41 and the nozzle cap body 42 are each obtained by injection molding a resin material with use of a mold. Additionally, the nozzle 40 does not necessarily need to have the double-block structure, and the nozzle main body 41 and the nozzle cap body 42 may be molded integrally. Alternatively, the nozzle 40 may be configured only by the nozzle main body 41.

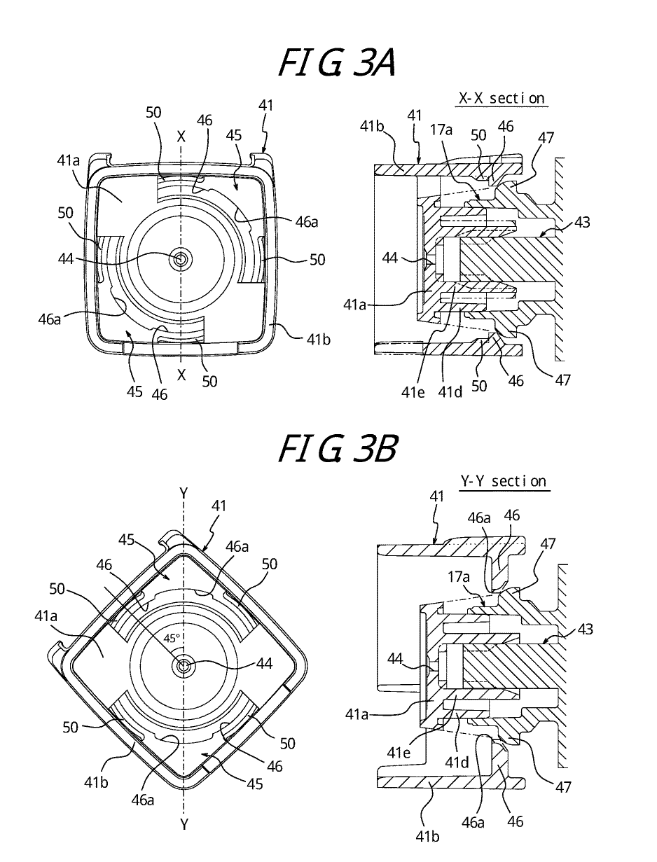

The nozzle main body 41 includes a plate-shaped partition wall 41a, which covers an opening end of the fitted portion 17a, and an outer circumferential wall 41b, which is contiguous with an outer circumference of the partition wall 41a to cover an outer circumference of the fitted portion 17a. As can be seen from FIGS. 3A and 3B, the outer circumferential wall 41b has a tubular shape that is substantially square as viewed from the front side.

The partition wall 41a of the nozzle main body 41 is provided with a dispensing hole 44, which extends through the partition wall 41a along the central axis of the outer circumferential wall 41b. The dispensing hole 44 is a small hole that is sufficiently smaller in sectional area than the delivery port 19. The partition wall 41a is further provided, on an inner surface thereof that faces to the fitted portion 17a, integrally with a cylindrical-shaped closing tubular portion 41d, which is disposed coaxially with the dispensing hole 44. With the closing tubular portion 41d being fitted on the inner side of the fitted portion 17a, the partition wall 41a closes the opening end of the fitted portion 17a. Moreover, the partition wall 41a is provided, on the inner surface thereof, integrally with a switch tubular portion 41e, which is disposed coaxially with the closing tubular portion 41d on the inner side of the closing tubular portion 41d. The switch tubular portion 41e is fitted on the outer side of the switch shaft portion 43. The closing tubular portion 41d and the switch tubular portion 41e are rotatable relative to the fitted portion 17a and the switch shaft portion 43. That is to say, the nozzle main body 41 is rotatable with respect to the fitted portion 17a about the axis of the partition wall 41a of the nozzle main body 41.

The switch shaft portion 43 is provided, on an outer circumferential surface in a predetermined range of the front end side thereof, with at least one groove extending in the axis line direction. The switch tubular portion 41e is also provided, on an inner circumferential surface thereof, with at least one groove extending in the axis line direction. These grooves are not in communication with each other when the nozzle main body 41 (nozzle 40) is in its closed position. On the other hand, these grooves are in communication with each other when the nozzle main body 41 is in its opened position in which the nozzle main body 41 is rotated 90 degrees with respect to the fitted portion 17a from the closed position. Accordingly, when the nozzle main body 41 is in its closed position, the dispensing hole 44 is in its closed state in which the liquid is prevented from being dispensed due to the dispensing hole 44 being blocked from the delivery port 19. When the nozzle main body 41 is in its opened position, the dispensing hole 44 is in its opened state in which the liquid may be dispensed through the dispensing hole 44 communicating with the delivery port 19. By thus rotating the nozzle 40 between the closed and the opened position, opening and closing of the dispensing hole 44 may be switched.

Herein, FIGS. 3A and 3B illustrate the state before the nozzle main body 41 is fitted to the fitted portion 17a. Front views are on the left side, and an X-X sectional view and a Y-Y sectional view are on the right side. As illustrated in the sectional views of FIGS. 3A and 3B, the fitted portion 17a is provided, on an outer circumferential surface thereof, with a pair of projecting portions 47, which are in undercut engagement with locking projections 46, which are later described. These protruding portions 47 are each formed in a plate shape protruding to the outer side in the radial direction from the outer circumferential surface of the fitted portion 17a and has a width in the circumferential direction that is approximately ¼ of the width of the corresponding locking projection 46. Additionally, although in the present embodiment the pair of projecting portions 47 is disposed on the left and the right side on the outer circumferential surface of the fitted portion 17a, the present disclosure is not limited to this embodiment. The pair of projecting portions 47 may be disposed on the upper and the lower side or any other sides.

As illustrated in the front views of the nozzle main body 41 of FIGS. 3A and 3B, the partition wall 41a of the nozzle main body 41 is provided with a pair of through holes 45, which extends along a joining portion between the partition wall 41a and the outer circumferential wall 41b. These through holes 45 each extend in a range of approximately 90 degrees about the central axis of the outer circumferential wall 41b and are formed as a pair of arc-shaped holes disposed in point symmetry about the central axis of the outer circumferential wall 41b.

Furthermore, the outer circumferential wall 41b of the nozzle main body 41 is provided with the pair of locking projections 46, which protrudes toward the inner side in the radial direction from an inner circumferential surface of the outer circumferential wall 41b. In the state where the nozzle main body 41 is fitted to the fitted portion 17a, the locking projections 46 are in undercut engagement with the projecting portions 47 of the fitted portion 17a. Accordingly, the nozzle main body 41 (the nozzle 40) is locked in a direction extending along the central axis thereof and is prevented from being detached from the fitting portion 17a by the projecting portions 47 while being held rotatably with respect to the fitted portion 17a. Additionally, the pair of locking projections 46 are disposed in point symmetry with each other within a range of approximately 90 degrees. Accordingly, even when the nozzle main body 41 is rotated between the closed and the opened position, the locking projections 46 are locked by the projecting portions 47, and the nozzle main body 41 is prevented from being detached from the fitted portion 17a.

As illustrated in FIGS. 3A and 3B, these locking projections 46 are each formed in an arc shape extending circumferentially along the inner circumferential surface of the outer circumferential wall 41b in the same range as the range of the corresponding through hole 45 so that the locking projection 46 is located in the range overlapping with the corresponding through hole 45 as viewed from a direction extending along the central axis of the outer circumferential wall 41b.

As illustrated in FIGS. 3A and 3B, each locking projection 46 is provided, in an inner edge portion in the radial direction thereof, with a concave portion 46a, which is recessed toward the outer side in the radial direction. The concave portion 46a is provided in a middle region in the circumferential direction of the inner edge portion of the locking projection 46. A width in the circumferential direction of the concave portion 46a is slightly greater than that of the corresponding projecting portion 47. As illustrated in FIG. 3B, the concave portion 46a in the present embodiment is provided in a manner such that the concave portion 46a comes to a position corresponding to the projecting portion 47 when the nozzle main body 41 is rotated 45 degrees in a rotational direction from the opened or the closed position. The degree of overlap in the undercut engagement between the locking projection 46 and the projecting portion 47 is reduced in the concave portion 46a of the locking projection 46. Accordingly, to fit the nozzle main body 41 to the fitted portion 17a, the concave portion 46a, in alignment with the projecting portion 47, is simply pushed in the axis line direction. By doing so, the locking projection 46 climbs over the projecting portion 47 easily. This prevents occurrence of the plastic deformation due to strong contact between the locking projection 46 and the projecting portion 47.

Furthermore, the outer circumferential wall 41b is provided with ribs 50, which protrude toward the inner side in the radial direction from the inner circumferential surface of the outer circumferential wall 41b. The ribs 50 abut against the projecting portions 47 in the state where the locking projections 46 are in undercut engagement with the projecting portions 47. This prevents rattling of the nozzle main body 41 in the state where the nozzle main body 41 is fitted to the fitted portion 17a. In order to provide the effect of reducing the rattling, the ribs 50 do not necessarily need to abut against the projecting portions 47 as long as the ribs 50 are provided to be adjacent to the projecting portions 47 in the state where the locking projections 46 are in undercut engagement with the projecting portions 47. Furthermore, when being provided intermittently in the circumferential direction, the ribs 50 reduce sliding friction caused by rotation of the nozzle 40 between the opened and the closed position. Additionally, in the present embodiment, the ribs 50 are arranged in four locations, that is to say, in the upper, the lower, the left, and the right part, on the outer circumferential wall 41b so that the ribs 50 abut against the projecting portions 47 when the nozzle 40 is in the opened and the closed position. The width in the circumferential direction of each rib 50 is approximately ¼ the width of each locking projection 46.

Additionally, reference numeral 48 denotes a projection provided on the outer circumferential surface of the fitted portion 17a. The projection 48 climbs over a projection 49, which is provided on the inner circumferential surface of the outer circumferential wall 41b, and this provides a click sensation when the nozzle main body 41 is rotated to the opened or the closed position. Furthermore, each locking projection 46 is provided, on both sides thereof, with stoppers S (which are not shown). Each of these stoppers S, against which the corresponding projecting portion 47 abuts, regulates the rotational angle of the nozzle main body 41 to be 90 degrees. By rotating the nozzle main body 41 in the range of 90 degrees, the dispensing hole 44 may be switched from the closed to the opened state, or from the opened to the closed state.

The nozzle cap body 42 includes a holding portion 42a, which is fitted to the inner side of the outer circumferential wall 41b, and a cover portion 42c, which is provided in an openable and closable manner via a hinge 42b. The holding portion 42a is provided with a locking claw 42d. The locking claw 42d is inserted through the through holes 45 of the nozzle main body 41 to be in undercut engagement with a rear surface of the partition wall 41a, thereby holding the nozzle cap body 42 in engagement with the nozzle main body 41. The cover portion 42c is provided, on a front end thereof, integrally with a tab portion 42e, which is held for opening and closing operations of the cover portion 42c. The cover portion 42c is also provided with a columnar-shaped projection 42f, with which the liquid dispensed in the form of spray from the dispensing hole 44 collides to be turned into foam in the closed position. The cover portion 42c, which covers the dispensing hole 44 in the closed position and which serves to change the form of dispensing the liquid dispensed from the dispensing hole 44, may have any shape etc. Furthermore, the cover portion 42c may also be a closing cap that simply covers the dispensing hole 44 to prevent the content liquid from being dispensed.

In the trigger-type liquid dispenser 1 with the above configuration according to the present embodiment, at the time of fitting the nozzle main body 41 to the fitted portion 17a, the nozzle main body 41 is pushed in easily with a little force by aligning the concave portions 46a with the projecting portions 47 as illustrated in FIG. 3B. Besides, the plastic deformation between the locking projections 46 and the projecting portions 47 is prevented, and the fitting stability of the nozzle 40 is improved.

Meanwhile, after the nozzle 40 is fitted, the nozzle 40 is basically arranged in the opened or the closed position. Accordingly, operation is not feasible in the state where the concave portions 46a are in engagement with the projecting portions 47. Especially when the liquid contained in the container 2 is dispensed, the nozzle 40 is in the opened state. This ensures, as illustrated in FIG. 3A, a sufficient degree of overlap in the undercut engagement between the locking projections 46 and the projections 47, and a sufficient fitting strength of the nozzle 40 with respect to the fitted portion 17a is obtained. Accordingly, even when pressure is increased in the delivery flow path P2 and in the nozzle 40, there is no fear of the nozzle 40 falling off, and this permits safe use.

Furthermore, in the trigger-type liquid dispenser 1 according to the present embodiment, the outer circumferential wall 41b is provided with the ribs 50, which abut against the projecting portions 47 in the state where the locking projections 46 are in undercut engagement with the projecting portions 47. This prevents rattling of the nozzle 40 and accordingly, improves operability and stabilizes the dispensing form of the liquid.

Moreover, in cases where the nozzle cap body 42 is provided as in the trigger-type liquid dispenser 1 according to the present embodiment, the form of dispensing the liquid may be switched. Accordingly, the dispensing form may be changed depending on applications, and convenience is further improved.

### Reference Signs List

1 Trigger-type liquid dispenser

2 Container

2a Mouth

2b Male screw

10 Dispenser main body

11 Body portion

11a Vent hole

12 Pump

13 Coupling tube

14 Fitting cap

14a Female screw

15 Sealing member

16 Standing portion

17 Extension portion

17a Fitted portion

18 Tube

19 Delivery port

20 Cylinder

20a Ambient air introduction port

21 Piston

21a Concave portion

22 Outlet/inlet hole

23 First check valve

24 Second check valve

25 Trigger

26 Pivot shaft

27 Pin member

28 Shroud

30 Upright and inverted dual mechanism

31 Check valve unit

31a Valve body

31b Valve chamber

31c Outlet hole

31d Inlet opening

31e Flow path used during inversion

40 Nozzle

41 Nozzle main body

41a Partition wall

41b Outer circumferential wall

41d Closing tubular portion

41e Switch tubular portion

42 Nozzle cap body

42a Holding portion

42b Hinge

42c Cover portion

42d Locking claw

42e Tab portion

43 Switch shaft portion

44 Dispensing hole

45 Through hole

46 Locking projection

46a Concave portion

47 Projecting portion

48 Projection

49 Projection

50 Rib

P1 Intake flow path

P2 Delivery flow path

S Plate spring

1. A trigger-type liquid dispenser comprising: a dispenser main body fitted to a mouth of a container containing a liquid; a pump configured, in response to operation of a trigger, to be actuated to pressure-feed the liquid contained in the container to a delivery port through a delivery flow path provided in the dispenser main body; and a nozzle fitted to the dispenser main body to dispense, to outside, the liquid pressure-fed to the delivery port, wherein
the dispenser main body includes a cylindrical-shaped fitted portion communicating with the delivery port,
the nozzle includes a partition wall, which covers an opening end of the fitted portion and which is provided with a dispensing hole, and a tubular-shaped outer circumferential wall, which is contiguous with an outer circumference of the partition wall to cover an outer circumference of the fitted portion, and the nozzle is rotatable with respect to the fitted portion between an opened position, in which the dispensing hole communicates with the delivery port, and a closed position, in which the dispensing hole is blocked from the delivery port,
the outer circumferential wall includes a locking projection that protrudes toward an inner side in a radial direction from an inner circumferential surface of the outer circumferential wall and that is in undercut engagement with a projecting portion provided on an outer circumferential surface of the fitted portion to thereby hold the nozzle in engagement with the fitted portion, and
the locking projection is provided, in an inner edge portion thereof, with a concave portion, in which a degree of the undercut engagement with the projecting portion is reduced when the nozzle is located between the opened and the closed position.

2. The trigger-type liquid dispenser according to claim 1, wherein
the nozzle is configured in a manner such that the nozzle comes to the closed position when being rotated 90 degrees to one side with respect to the fitted portion from the opened position, and
the concave portion is arranged to engage with the projecting portion in a state where the nozzle is rotated 45 degrees in a direction toward the closed position from the opened position.

3. The trigger-type liquid dispenser according to claim 1, wherein
the outer circumferential wall includes a rib that protrudes toward the inner side in the radial direction from the inner circumferential surface of the outer circumferential wall and that abuts against the projecting portion in a state where the locking projection is in undercut engagement with the projecting portion.

4. The trigger-type liquid dispenser according to claim 1, wherein
the nozzle includes:
a nozzle main body in which the partition wall and the outer circumferential wall are formed integrally; and
a nozzle cap body that is fitted to the nozzle main body, that is configured to cover the dispensing hole in an openable and closable manner via a hinge, and that is configured to change a dispensing form.

5. The trigger-type liquid dispenser according to claim 2, wherein
the outer circumferential wall includes a rib that protrudes toward the inner side in the radial direction from the inner circumferential surface of the outer circumferential wall and that abuts against the projecting portion in a state where the locking projection is in undercut engagement with the projecting portion.

6. The trigger-type liquid dispenser according to claim 2, wherein
the nozzle includes:
a nozzle main body in which the partition wall and the outer circumferential wall are formed integrally; and
a nozzle cap body that is fitted to the nozzle main body, that is configured to cover the dispensing hole in an openable and closable manner via a hinge, and that is configured to change a dispensing form.

7. The trigger-type liquid dispenser according to claim 3, wherein
the nozzle includes:
a nozzle main body in which the partition wall and the outer circumferential wall are formed integrally; and
a nozzle cap body that is fitted to the nozzle main body, that is configured to cover the dispensing hole in an openable and closable manner via a hinge, and that is configured to change a dispensing form.

8. The trigger-type liquid dispenser according to claim 5, wherein
the nozzle includes:
a nozzle main body in which the partition wall and the outer circumferential wall are formed integrally; and
a nozzle cap body that is fitted to the nozzle main body, that is configured to cover the dispensing hole in an openable and closable manner via a hinge, and that is configured to change a dispensing form.
